(19) United States
(12) Patent Application Publication
(10) Pub. No.: US 2005/0279747 A1
(43) Pub. Date: Dec. 22, 2005

(54) Cupcake holder

(76) Inventor: Leanna Madagan, Winchester, VA (US)

Correspondence Address: REED SMITH LLP, Suite 1400, 3110 Fairview Park Drive, Falls Church, VA, 22042, US

(21) Appl. No.: 10/860,132

(22) Filed: Jun. 4, 2004

(51) Int. Cl. A23B 4/00

(52) U.S. Cl. 220/475

(57) ABSTRACT

A cupcake holder includes at least one supporting body having a convex supporting surface with a plurality of cup-shaped hollow cake holding seats thereon, a supporting wall suspended from the periphery of the supporting surface to a horizontal level.

### BACKGROUND OF THE INVENTION

1. Field of the Invention

The invention relates to a cupcake holder comprising at least one holding body with a convex upper surface having a plurality of cup-shaped hollow cake holding seats thereon, a supporting wall suspended from the periphery of the supporting surface to a horizontal level. Optionally, a supporting bottom plate is provided to connect the base of the wall to fix the holding body in a convex state. The cup shape can be cylindrical, square, cone, etc.

2. Description of Related Arts

U.S. Pat. No. D112,347 shows a cake holder designed for easy transportation such that it only provides a flat supporting surface rather than any convex supporting surface. U.S. Pat. Nos. D228,443 and D280,689 also provide a flat supporting surface. U.S. Pat. No. D348,378 provides three flat supporting surfaces. U.S. Pat. No. D459,988 provides a foldable flat package with a handle.

U.S. Pat. No. 3,034,496 provides a flat supporting surface over a water chamber so to warm or cool food placed in the cup-shaped members. U.S. Pat. Nos. 4,446,982 and 5,779,080 provide a flat supporting surface of a baking pan. U.S. Pat. No. 5,899,353 provides a flat supporting platform for cupcakes.

A conventional 18-piece cupcake holder as depicted in FIGS. 11-13 relies upon a strap 21 engaging/interlocking with two holes 25 at the edge on a planar main body 20 to hold the main body 20 in a convex state. The design was developed by the Cupcake Bouquet Enterprises (Grand Blanc, Mich.) to present cupcakes in a bouquet. However, the strip and the holes deteriorate after multiple uses.

Currently, there is need for a cupcake holder which lasts longer.

### SUMMARY OF THE INVENTION

It is a purpose of this invention to provide a long-lasting cupcake holder for repeated uses for presentation and serving cupcakes.

It is an object of the invention to provide improved elements and arrangements thereof in an apparatus for inexpensive, dependable and fully effective in presentation and serving cupcakes.

These and other objects of the present invention will become readily apparent upon further review of the following specification and drawings.

### BRIEF DESCRIPTION OF THE DRAWINGS

The foregoing and additional features and characteristics of the present invention will become more apparent from the following detailed description considered with reference to the accompanying drawings in which like reference numerals designate like elements and wherein:

FIG. 1 shows a perspective view of the first embodiment of the cupcake holder according to the present invention;

FIG. 2 shows a side view of the cupcake holder in FIG. 1;

FIGS. 3A and 3B show a top view and a side view of the top level of the cupcake holder in FIG. 1;

FIGS. 4A and 4B show a top view and a side view of the lower level of the cupcake holder in FIG. 1;

FIG. 5 shows a perspective view of a stanchion spacer on a support of the stanchion cupcakes holder in FIG. 1;

FIGS. 6A and 6B show a top view and a upside-down perspective view of the stanchion spacer of the cupcake holder in FIG. 5;

FIG. 7 shows a perspective view of the second embodiment of the cupcake holder according to the present invention;

FIGS. 8A and 8B show a top view and a side view of the cupcake holder in FIG. 7;

FIGS. 9A and 9B show a top view and a side view of the cover of the cupcake holder in FIG. 7;

FIG. 10 shows a perspective view of the third embodiment of the cupcake holder according to the present invention;

FIG. 11 shows a perspective view of a conventional cupcakes holder;

FIGS. 12A and 12B show a top view and a back view of the conventional cupcake holder in FIG. 11; and

FIG. 13 shows a side view of the conventional cupcake holder in FIG. 11.

### DESCRIPTION OF THE PREFERRED EMBODIMENTS

The present invention provides cupcake holders that can be used both during presentation and serving of cupcakes in a wedding, a baby or bridal shower, a gala, or other parties. During presentation and serving, it is highly desirable that the cupcakes be supported in an upright and outward orientation so can be easily pick up with fingers to a plate.

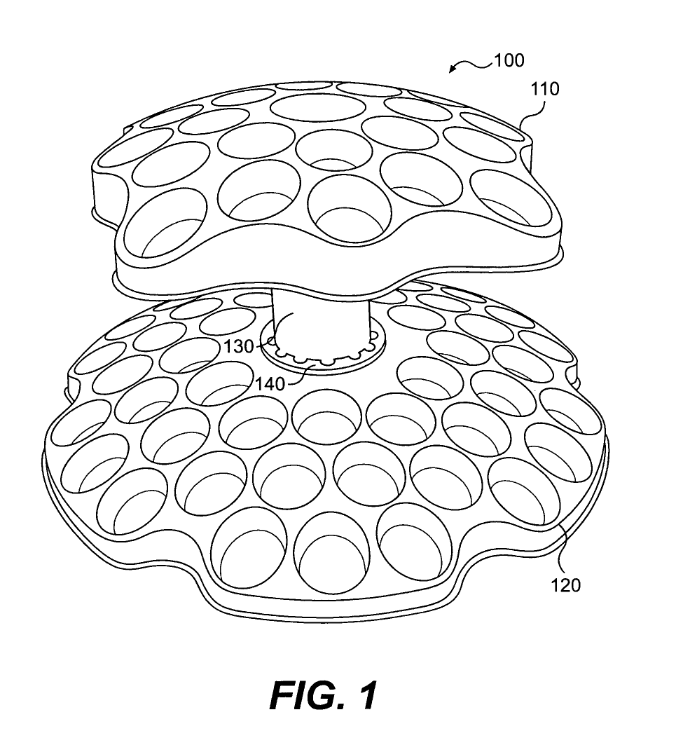

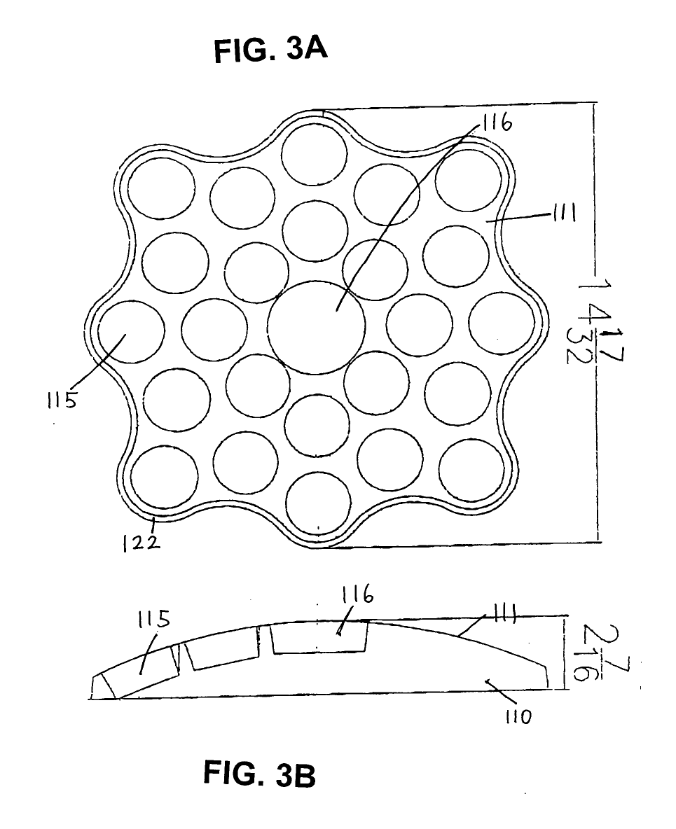

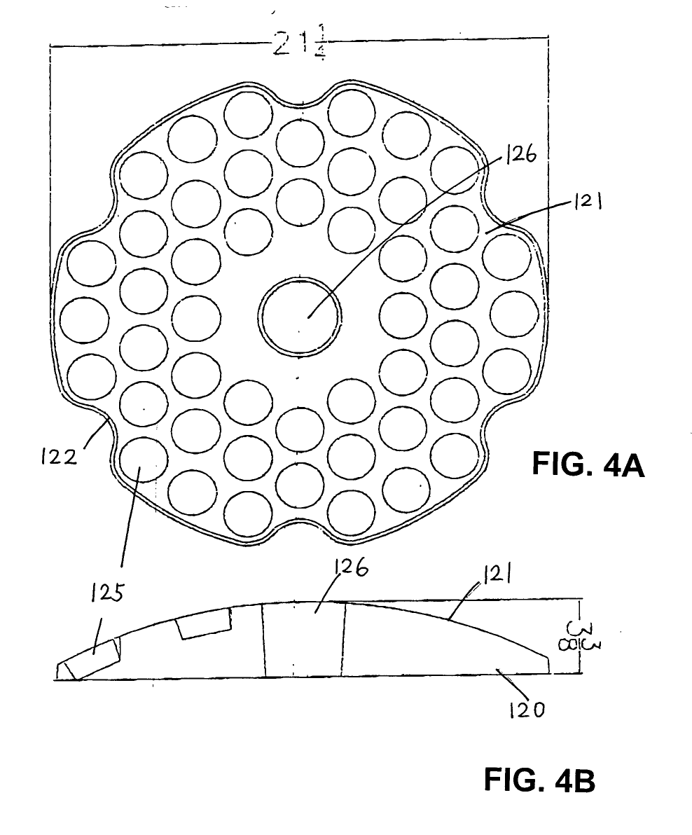

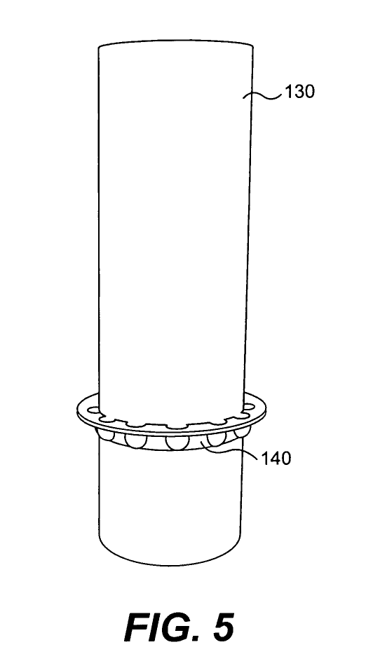

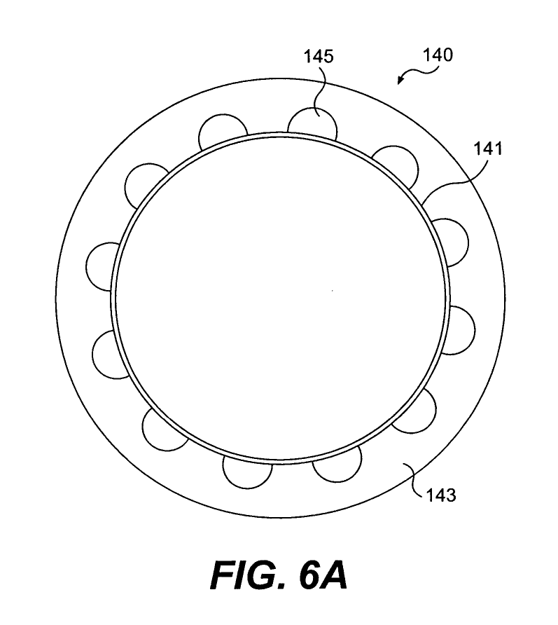

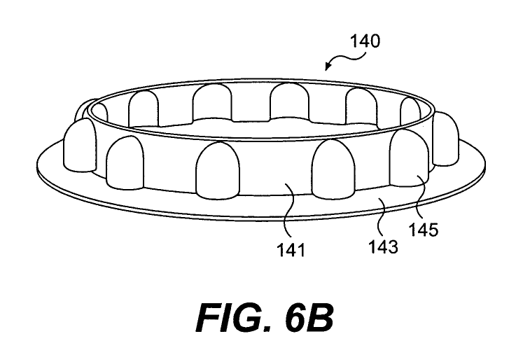

As shown in FIG. 1, the first embodiment of an cupcake holder 100 according to the present invention has a convex, generally rectangular, 24-piece supporting body 110 (FIG. 3), and a convex, generally circular 48-piece supporting body 120 (FIG. 4). Each of the supporting bodies has an upper supporting surface 111, 121 with a plurality of hollow circular cupcake support seats 115, 125 disposed thereon for receiving cupcakes thereon, and a supporting wall 112, 122. Each supporting body is molded from a plastic (i.e., PVC) or other similar material to ensure it is lightweight, but capable of supporting the weight of the respective number of cupcakes. The respective supporting wall curves toward the center of the supporting body in a plurality of waves for a top view to achieve several purposes: to increase the wall surface so as to provide more support for the weight of the supporting body, and to provide a stylish shape and visual effect.

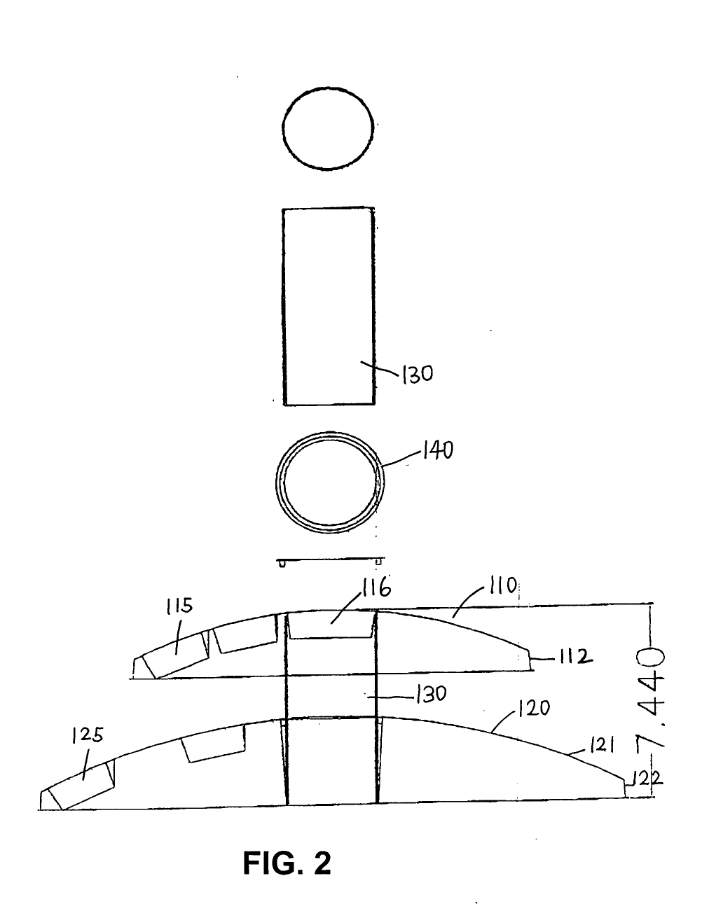

The upper supporting body 110 is supported by a support stanchion 130 standing on the top of the lower supporting body 120 (FIG. 2). The support stanchion 130 is a hollow cylinder made from plastic (i.e., PVC) or other similar material. The upper supporting body 110 has it center hollow circular seat 110 (FIG. 3B) that directly engages/interlocks with the upper end of the support stanchion 130 by the weight of the upper supporting body 110. The lower supporting body 120 has it center hollow circular seat 210 (FIG. 4B) that engages/interlocks with the lower end of the support stanchion 130 by the weight of the support stanchion 130 and via a stanchion spacer 140, since the diameter of center hollow circular seat 116 is larger than the outer diameter of the support stanchion 130. The engagement or interlocking relationship between the center seat of the supporting bodies and the support stanchion 130 depend on their relative diameters. They can engage directly if the diameters are the same; otherwise, a stanchion spacer is necessary for coupling the different diameters.

The ring-shaped stanchion spacer 140 has a vertical inner wall 141, a horizontal ring 143 connecting the horizontal ring 143 in a L-shape manner with twelve (12) half-finger-tip-shaped hollow sub-spacers 145 disposed evenly therebetween the L. The support stanchion 130 contacts the vertical inner wall 141 with a portion of its outer surface. The center hollow circular seat 126 contacts the horizontal ring 143 at its facing-downward edge, and contacts the twelve (12) half-finger-tip-shaped hollow sub-spacers 145 at the respective nail portions 146.

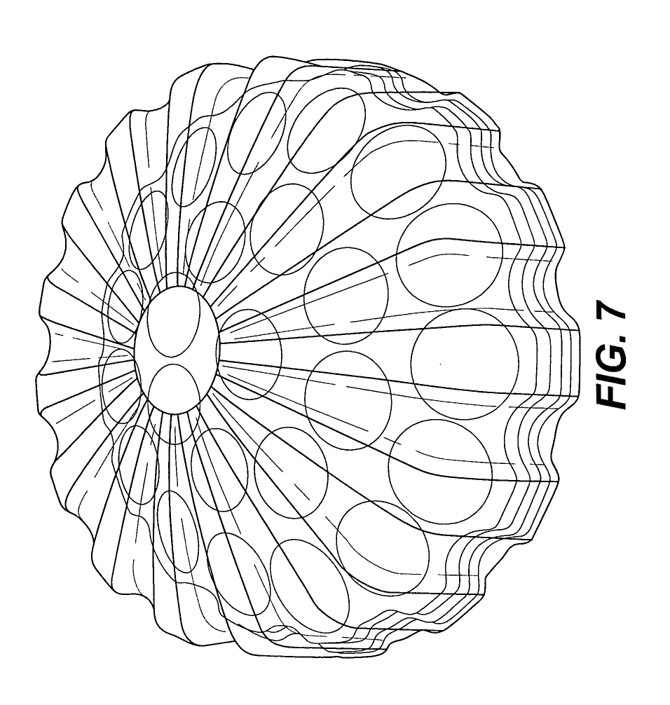

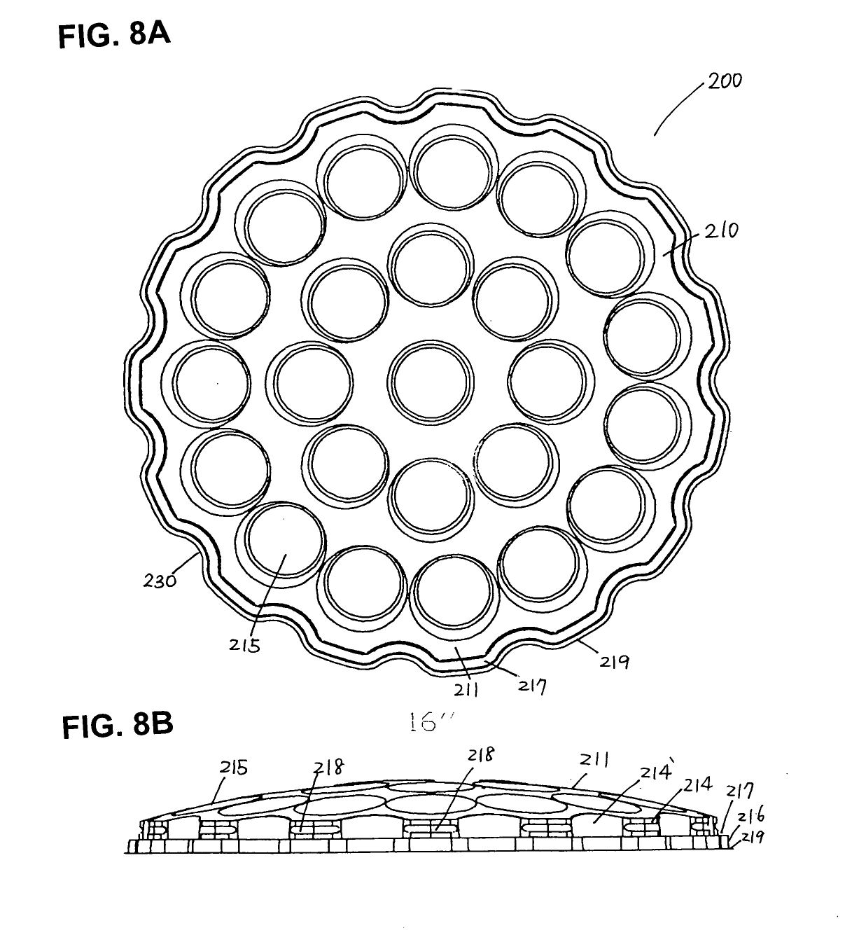

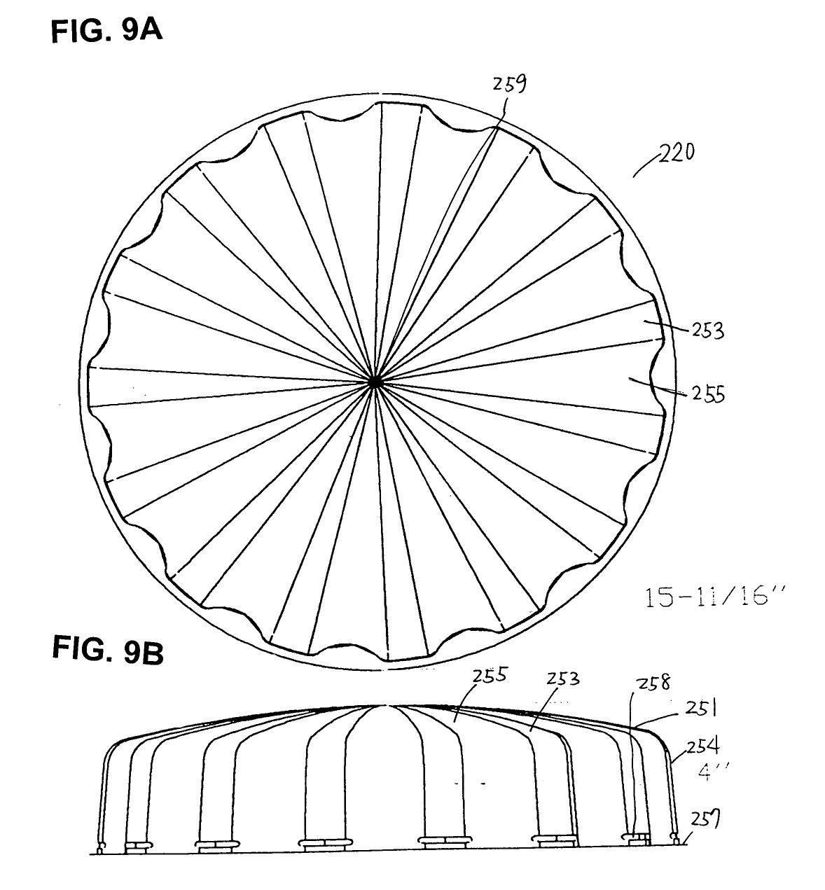

As shown in FIGS. 7-9, the second embodiment of an cupcake holder 200 according to the present invention has a convex, generally rectangular, 24-piece supporting body 210 (FIG. 8), and a convex, generally circular cover 250 (FIG. 9). The supporting body 210 has an upper supporting surface 211 with a plurality of hollow circular cupcake support seats 215 disposed thereon for receiving cupcakes thereon, and a supporting wall 230. The supporting body 210 is molded from a plastic (i.e., PVC) or other similar material to ensure it is lightweight, but capable of supporting the weight of the respective number of cupcakes. The supporting wall 230 has a two-step profile with a first wall 214 connecting between the upper supporting surface 211 and a covering receiving surface 217, and a second wall 216 connecting between the covering receiving surface 217 and a ground surface 219. The supporting wall 230 curves toward the center of the supporting body 210 in a plurality of waves for a top view to achieve several purposes: to increase the wall surface so as to provide more support for the weight of the supporting body 210, to provide a stylish shape and visual effect, and to interlock with relevant portion of the cover 250. In particular, a plurality of interlocking grooves 218 are provided on the first wall 214 for receiving projections of the cover 250.

The cover 250 has a convex cover supporting surface 251 and a cover supporting wall 252, both of which share a plurality of alternate strip patterns 253 and valley patterns 255 radiating from the center 259 of the cover 250 and turning into strip side wall portions 254 and valley side wall portions 256. The cover supporting wall 252 includes the alternate strip side wall portions 254, and the valley side wall portions 256, which are surrounded by a flat skirt 257 resting on the covering receiving surface 217 of the supporting body 210. The cover 250 and the supporting body 210 interlock with each other via at least three mechanisms: the valley side walls 256 of the cover 250 interlocking with the valley receiving wall 214′ of the supporting body 210, the strip side walls 254 of the cover 250 interlocking with the first wall 214, and the projections 258 on strip side walls 254 interlocking with the interlocking grooves 218 of the supporting body 210. The cover 250 is molded from a plastic (i.e., PVC) or other similar transparent material to ensure it is lightweight, but capable of supporting the weight of the cover itself.

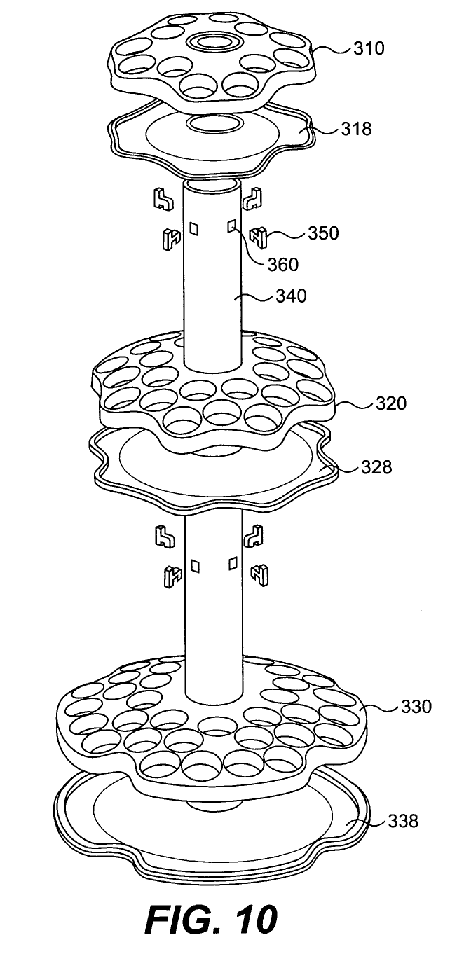

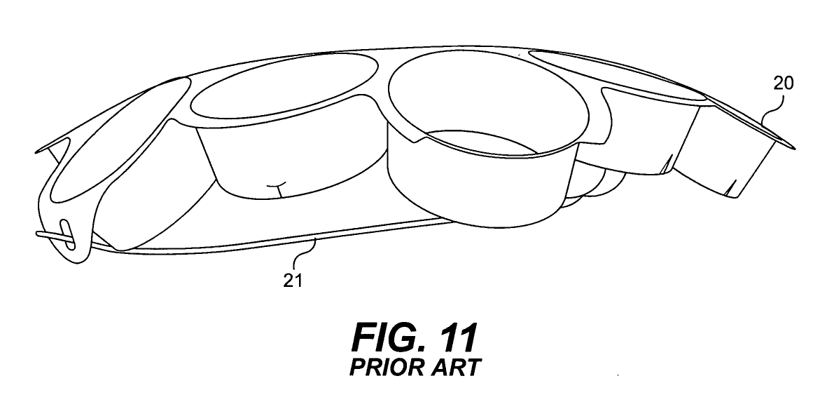

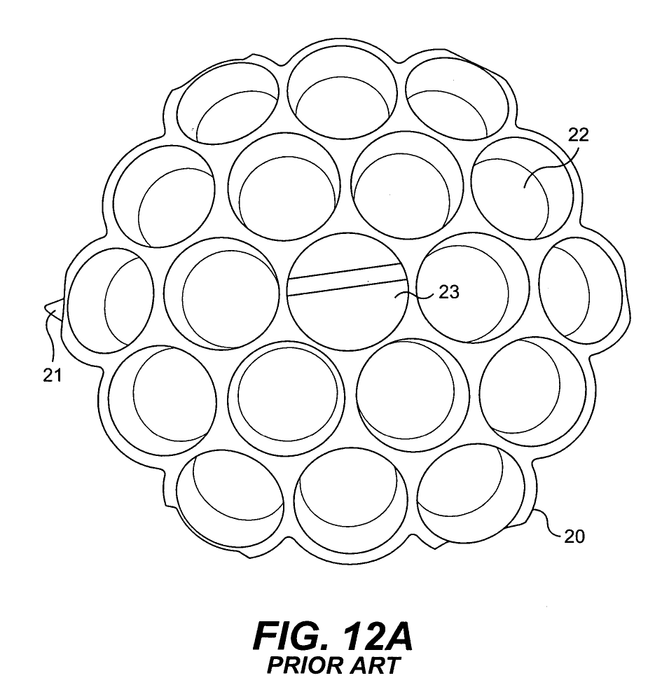

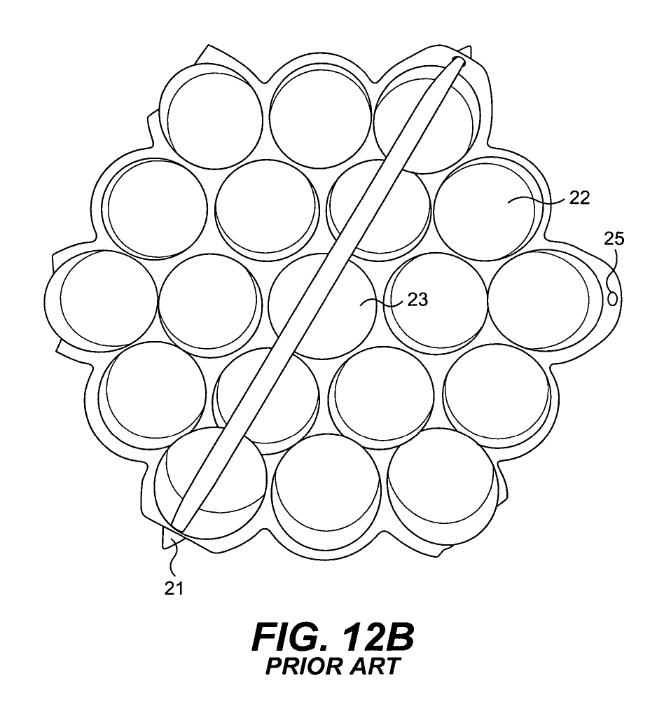

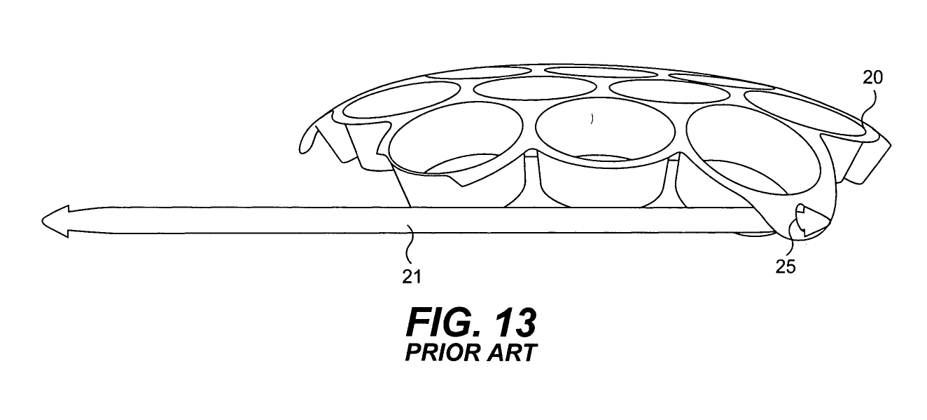

As shown in FIG. 10, the third embodiment of an cupcake holder 300 according to the present invention has a convex, generally rectangular, 12-piece supporting body 310, a convex, generally rectangular 24-piece supporting body 320, and a convex, generally circular 36-piece supporting body 330. Each of the supporting bodies has an upper supporting surface 311, 321; 331 with a plurality of hollow circular cupcake support seats 315, 325, 335 disposed thereon for receiving cupcakes thereon, and a supporting wall 312, 322, 332. Each supporting body is molded from a plastic (i.e., PVC) or other similar material to ensure it is lightweight, but capable of supporting the weight of the respective number of cupcakes. The respective supporting wall curves toward the center of the supporting body in a plurality of waves for a top view to achieve several purposes: to increase the wall surface so as to provide more support for the weight of the supporting body, and to provide a stylish shape and visual effect. In the third embodiment, each supporting body is further supported with a supporting plate 318, 328 or 338 with the same circumferential shape as the respective supporting body. Each supporting plate is then fastened onto the support stanchion 340 with a plurality of bolts 350 (e.g. four bolts) into sockets on the support stanchion 340 on predetermined potions. Other detachable interlocking or fasten means, such as Velcro®, can be used to replace the bolts and the sockets.

Each of the supporting plate 318, 328 or 338 has a central hole, a convex supporting body for supporting the bottoms of the cupcake support seats, and a flat skirt. Each flat skirt has a skirt projections having the same circumferential shape as the respective supporting body so as to interlock with the edge of the respective supporting wall of the supporting body (at either inside or outside of the supporting wall).

The number of the supporting bodies can go beyond three. In an embodiment having a plurality of supporting bodies, there are progressively fewer cup-shaped hollow cake holding seats from bottom to top to keep the holder in balance. The number of the cupcake seats on each supporting body can be any number other than 12, 24, 36 and 48. The cup shape can be cylindrical, square, cone, etc. The shape of the hollow cake holding seats may be the same or different. For example, a combination of cylindrical-shaped, square-shaped, and cone-shaped seats may be formed. Each of the supporting bodies is generally shaped square, circular, or hexagonal, though other shapes may be used.

The principles, preferred embodiments and modes of operation of the present invention have been described in the foregoing specification. However, the invention which is intended to be protected is not limited to the particular embodiments disclosed. The embodiments described herein are illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A cupcake holder, comprising: at least one supporting body having a convex supporting surface with a plurality of cup-shaped hollow cake holding seats thereon, a supporting wall suspended from the periphery of the supporting surface.

2. The cupcake holder according to claim 1, wherein said supporting body further has a supporting bottom plate provided to connect to a base of the supporting wall to fix the supporting surface in a convex state.

3. The cupcake holder according to claim 1, wherein a shape of one of the hollow cake holding seats is cylindrical, square, or cone.

4. The cupcake holder according to claim 1, wherein said supporting body is molded from a PVC sheet.

5. The cupcake holder according to claim 1, wherein said supporting wall curves toward the center of the supporting body in a plurality of waves for a top view to increase the wall surface.

6. The cupcake holder according to claim 1, comprising a upper and a bottom supporting bodies and a support stanchion supporting the two supporting bodies.

7. The cupcake holder according to claim 6, wherein the upper supporting body is supported by the support stanchion above the bottom supporting body.

8. The cupcake holder according to claim 6, wherein the support stanchion is a hollow PVC cylinder.

9. The cupcake holder according to claim 7, wherein the upper supporting body has a center hollow circular seat thereof that directly engages with the upper end of the support stanchion, the diameter of the center hollow circular seat being identical with the outer diameter of the support stanchion.

10. The cupcake holder according to claim 7, wherein the bottom supporting body has a center hollow circular seat thereof that directly engages with the lower end of the support stanchion, the diameter of the center hollow circular seat being identical with the outer diameter of the support stanchion.

11. The cupcake holder according to claim 7, wherein the upper supporting body has a center hollow circular seat thereof that interlocks with the upper end of the support stanchion via a stanchion spacer, the diameter of center hollow circular seat being larger or smaller than the outer diameter of the support stanchion.

12. The cupcake holder according to claim 7, wherein the bottom supporting body has a center hollow circular seat thereof that interlocks with the lower end of the support stanchion via a stanchion spacer, the diameter of center hollow circular seat being larger or smaller than the outer diameter of the support stanchion.

13. The cupcake holder according to claim 11, wherein the stanchion spacer is ring-shaped.

14. The cupcake holder according to claim 12, wherein the stanchion spacer is ring-shaped.

15. The cupcake holder according to claim 11, wherein the stanchion spacer has a vertical inner wall contacting the outer surface of the support stanchion, and a horizontal ring contacting the center hollow circular seat with its edge.

16. The cupcake holder according to claim 12, wherein the stanchion spacer has a vertical inner wall contacting the outer surface of the support stanchion, and a horizontal ring contacting the center hollow circular seat with its edge.

17. The cupcake holder according to claim 15, wherein the vertical inner wall connects the horizontal ring in a L-shape manner with a plurality of half-finger-tip-shaped hollow sub-spacers disposed evenly therebetween.

18. The cupcake holder according to claim 16, wherein the vertical inner wall connects the horizontal ring in a L-shape manner with a plurality of half-finger-tip-shaped hollow sub-spacers disposed evenly therebetween.

19. The cupcake holder according to claim 1, wherein each of said supporting bodies is substantially one of square-shaped, circular-shaped, and hexagonal-shaped.

20. The cupcake holder according to claim 1, comprising a plurality of supporting bodies with progressively fewer cup-shaped hollow cake holding seats from bottom to top.

21. The cupcake holder according to claim 2, wherein the supporting bottom plate is provided with a projection along an edge thereof to interlock with the base of the supporting wall.

22. The cupcake holder according to claim 2, wherein the supporting bottom plate has a convex supporting body for supporting bottoms of the cake holding seats.

23. The cupcake holder according to claim 6, wherein said supporting body further has a supporting bottom plate provided to connect to a base of the supporting wall to fix the supporting surface in a convex state, the supporting bottom plate for the upper supporting body is fastened onto the support stanchion.

24. The cupcake holder according to claim 24, wherein the supporting bottom plate for the upper supporting body is fastened onto the support stanchion by a plurality of bolts into sockets on the support stanchion on predetermined potions.

25. The cupcake holder according to claim 1, wherein the supporting wall has a two-step profile with a first wall connecting between the convex supporting surface and a covering receiving surface, and a second wall connecting between the covering receiving surface and a ground surface.

26. The cupcake holder according to claim 1, further comprising a cover, wherein the supporting wall includes a plurality of interlocking grooves for receiving projections of the cover.

27. The cupcake holder according to claim 1, further comprising a cover.

28. The cupcake holder according to claim 27, wherein the cover has a convex cover supporting surface and a cover supporting wall.

29. The cupcake holder according to claim 28, wherein the convex cover supporting surface and the cover supporting wall share a plurality of alternate strip patterns and valley patterns radiating from a center of the cover.

30. The cupcake holder according to claim 29, wherein the cover supporting wall includes alternate strip side wall portions and valley side wall portions which are surrounded by a flat skirt.

31. The cupcake holder according to claim 30, wherein the supporting wall has a two-step profile with a first wall connecting between the convex supporting surface and a covering receiving surface, and a second wall connecting between the covering receiving surface and a ground surface, and
wherein the valley side wall portions of the cover interlock with the valley receiving wall of the supporting body, and the strip side wall portions of the cover interlock with the first wall of the supporting body,

32. The cupcake holder according to claim 27, wherein the cover 250 is molded from a transparent plastic material.
